(19) United States
(12) Patent Application Publication
(10) Pub. No.: US 2023/0308185 A1
(43) Pub. Date: Sep. 28, 2023

(54) OPTICAL COMMUNICATION SYSTEM AND OPTICAL COMMUNICATION METHOD

(71) Applicant: MITSUBISHI ELECTRIC CORPORATION, Tokyo (JP)

(72) Inventor: Satoshi YOSHIMA, Tokyo (JP)

(73) Assignee: MITSUBISHI ELECTRIC CORPORATION, Tokyo (JP)

(21) Appl. No.: 18/143,204

(22) Filed: May 4, 2023

Related U.S. Application Data
(63) Continuation of application No. PCT/JP2021/000339, filed on Jan. 7, 2021.

(51) Int. Cl. H04B 10/2575; H04B 10/61; H04B 10/80

(52) U.S. Cl. CPC H04B 10/25759; H04B 10/614; H04B 10/802

(57) ABSTRACT

An optical communication system includes: transmitting apparatuses that convert a first data signal into a plurality of optical-signal packet signals; optical couplers that combine optical-signal packet signals and split the combined optical-signal packet signals into a plurality of optical-signal transmission signals; receiving apparatuses that receive the optical-signal transmission signals and convert the optical-signal transmission signals into a second data signal and a controller that controls operation of the transmitting apparatuses and the receiving apparatuses. The transmitting apparatuses transmit the plurality of optical-signal packet signals, allocating communication resources thereto to prevent the transmitted optical-signal packet signals from colliding with the optical-signal packet signals transmitted from the other transmitting apparatuses. The receiving apparatuses convert the optical-signal transmission signals into electrical-signal transmission signals, select specified signal portions, and output the selected signal portions as the second data signal.

### CROSS-REFERENCE TO RELATED APPLICATION

This application is a continuation application of International Application PCT/JP2021/00039, filed on Jan. 7, 2021, and designating the U.S., the entire contents of which are incorporated herein by reference.

### BACKGROUND OF THE INVENTION

### 1. Field of the Invention

The present disclosure relates to an optical communication system, a control circuit, a storage medium, and an optical communication method for transmitting signals in the optical region.

### 2. Description of the Related Art

Some conventional optical switch device includes N wavelength group generation units each including M fixed-wavelength light sources, M split/selection units, and MN tunable filters, as described in WO 2017/131125 A. As for the optical switch device described in WO 2017/131125 A, the split/selection units provide M selectable paths for data input from MN input ports, and the tunable filters provide N selectable wavelengths. This allows optical switch device to switch the path for data to be output from desired output ports. The configuration of the optical switch device described in WO 2017/131125 A has an advantage that the optical switch device can be implemented by smaller-scale hardware than an MNxMN-scale spatial matrix switch using micro-electro-mechanical systems (MEMS) or the like.

The split/selection units of the optical switch device described in WO 2017/131125 A are implemented by a delivery-and-coupling (DC) switch or a multicast switch, and include 1×M optical couplers and M×1 optical switches. Unfortunately, the optical switches, which are active components, suffers from a problem of a higher failure rate than passive components such as optical couplers, resulting in a reduction in the reliability of the entire system. In addition, the optical switch device with an increased switch scale requires the insertion of optical amplifiers such as erbium-doped fiber amplifiers (EDFAs) to compensate for losses such as splitting losses and combining losses of the optical couplers used in the split/selection units. Unfortunately, the optical amplifiers, which are active components like the optical switches, suffers from a problem a higher failure rate than passive components, resulting in a reduction in the reliability of the entire system. Further, the optical switch device with a larger switch scale provides a longer switching time, which reduces line efficiency.

### SUMMARY OF THE INVENTION

In order to solve the above-described problems, an optical communication system according to the present disclosure comprises: a plurality of optical transmitting apparatuses each to convert a first data signal that is an electrical signal into a plurality of optical-signal packet signals and transmit the plurality of optical-signal packet signals; a plurality of optical couplers each to combine optical-signal packet signals transmitted from fewer than all of the plurality of optical transmitting apparatuses, the fewer optical transmitting apparatuses being different from each other, split the combined optical-signal packet signals into a plurality of optical-signal transmission signals of the same information, and output the plurality of optical-signal transmission signals; a plurality of optical receiving apparatuses each to receive optical-signal transmission signals from the plurality of optical couplers, the received optical-signal transmission signals each being one of the separate optical-signal transmission signals provided by a corresponding one of the plurality of optical couplers, convert the optical-signal transmission signals into a second data signal that is an electrical signal, and output the second data signal; and a controller to control operation of the plurality of optical transmitting apparatuses and the plurality of optical receiving apparatuses, wherein the number of signals combined by each optical coupler is smaller than the number of the plurality of optical transmitting apparatuses, on the basis of a first control signal acquired from the controller, each optical transmitting apparatus transmits the plurality of optical-signal packet signals, allocating communication resources thereto in such a manner as to prevent the transmitted optical-signal packet signals from colliding with the optical-signal packet signals transmitted from the other optical transmitting apparatuses, and each optical receiving apparatus converts the optical-signal transmission signals into electrical-signal transmission signals, and, on the basis of a second control signal acquired from the controller, selects specified signal portions from the electrical-signal transmission signals and outputs the selected signal portions as the second data signal.

### BRIEF DESCRIPTION OF THE DRAWINGS

FIG. 1 is a diagram illustrating an example configuration of an optical communication system according to a first embodiment;

FIG. 2 is a diagram illustrating an example of signals transmitted in the optical communication system according to the first embodiment;

FIG. 3 is a flowchart illustrating the operation of the optical communication system according to the first embodiment;

FIG. 4 is a diagram illustrating an example configuration of processing circuitry when a processor and memory implement processing circuitry included in the optical communication system according to the first embodiment;

FIG. 5 is a diagram illustrating an example of processing circuitry when dedicated hardware constitutes the processing circuitry included in the optical communication system according to the first embodiment;

FIG. 6 is a diagram illustrating an example configuration of an optical communication system according to a second embodiment;

FIG. 7 is a diagram illustrating an example of signals transmitted in the optical communication system according to the second embodiment;

FIG. 8 is a diagram illustrating an example configuration of an optical communication system according to a third embodiment;

FIG. 9 is a diagram illustrating an example of signals transmitted in the optical communication system according to the third embodiment;

FIG. 10 is a diagram illustrating an example configuration of an optical communication system according to a fourth embodiment; and

FIG. 11 is a diagram illustrating an example of signals transmitted in the optical communication system according to the fourth embodiment.

### DETAILED DESCRIPTION OF THE PREFERRED EMBODIMENTS

An optical communication system, a control circuit, a storage medium, and an optical communication method according to embodiments of the present disclosure will be hereinafter described in detail with reference to the drawings.

### First Embodiment

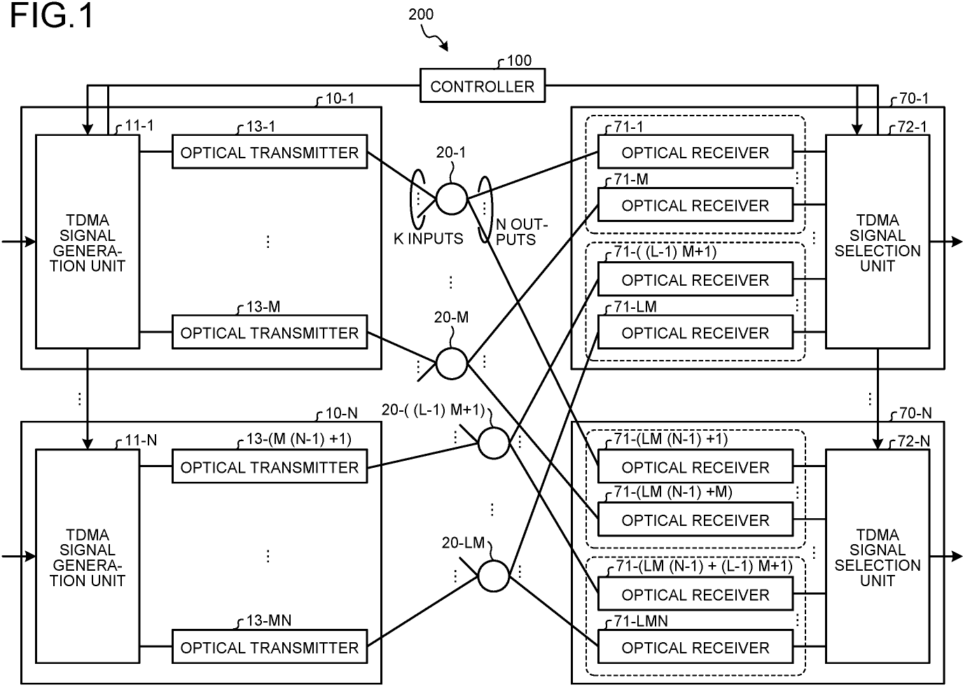

FIG. 1 is a diagram illustrating an example configuration of an optical communication system 200 according to a first embodiment. The optical communication system 200 illustrated in FIG. 1 includes N input ports and N output ports (not illustrated), and performs switching between the N input ports and the N output ports by time-division multiple access (TDMA). The optical communication system 200 includes TDMA signal generation units 11-1 to 11-N, optical transmitters 13-1 to 13-MN, optical couplers 20-1 to 20-LM, optical receivers 71-1 to 71-LMN, TDMA signal selection units 72-1 to 72-N, and a controller 100. L, M, and N are integers greater than or equal to two. L<N holds true.

In the optical communication system 200, the TDMA signal generation unit 11-1 and the optical transmitters 13-1 to 13-M define an optical transmitting apparatus 10-1, the TDMA signal generation unit 11-2 and the optical transmitters 13-(M+1) to 13-M2 define an optical transmitting apparatus 10-2, ..., and the TDMA signal generation unit 11-N and the optical transmitters 13-(M(N-1)+1) to 13-MN define an optical transmitting apparatus 10-N. The optical receivers 71-1 to 71-LM and the TDMA signal selection unit 72-1 define an optical receiving apparatus 70-1, the optical receivers 71-(LM+1) to 71-LM2 and the TDMA signal selection unit 72-2 define an optical receiving apparatus 70-2, ..., and the optical receivers 71-(LM(N-1)+1) to 71-LMN and the TDMA signal selection unit 72-N define an optical receiving apparatus 70-N. The optical couplers 20-1 to 20-LM are, for example, power splitters.

In the following description, the optical transmitting apparatuses 10-1 to 10-N are sometimes referred to as optical transmitting apparatuses 10 when not distinguished, the TDMA signal generation units 11-1 to 11-N are sometimes referred to as TDMA signal generation units 11 when not distinguished, and the optical transmitters 13-1 to 13-MN are sometimes referred to as optical transmitters 13 when not distinguished. The optical couplers 20-1 to 20-LM are sometimes referred to as optical couplers 20 when not distinguished. The optical receiving apparatuses 70-1 to 70-N are sometimes referred to as optical receiving apparatuses 70 when not distinguished, the optical receivers 71-1 to 71-LMN are sometimes referred to as optical receivers 71 when not distinguished, and the TDMA signal selection units 72-1 to 72-N are sometimes referred to as TDMA signal selection units 72 when not distinguished.

The TDMA signal generation units 11-1 to 11-N acquire, from the input ports described above, a first data signal that is an electrical signal required to be transferred. The TDMA signal generation units 11-1 to 11-N acquire, from the controller 100, a first control signal including a reference clock generated by the controller 100 and a transmission timing signal. The transmission signal is a communication resource allocation. The reference clock defines a transmission/reception transfer rate of optical-signal packet signals. The controller 100 determines the communication resource allocation on the basis of a request for communication of the first data signal acquired at the input ports of the optical communication system 200. The first embodiment is based on the assumption that communication resources are time slots.

The TDMA signal generation units 11-1 to 11-N once buffer the acquired first data signal, and, on the basis of the transmission timing signal included in the first control signal, convert the first data signal into intermittent electrical-signal packet signals on the time axis, adjusting timing in such a manner that the packet signals avoid colliding on the time axis with electrical-signal packet signals that are time-division multiplexed signals generated by the other TDMA signal generation units 11. The TDMA signal generation units 11-1 to 11-N then transmit the electrical-signal packet signals to the optical transmitters 13 connected thereto. For example, the TDMA signal generation unit 11-1 transmits the electrical-signal packet signals to the optical transmitters 13-1 to 13-M. Other portions than the intermittent signal portion in each electrical-signal packet signal transmitted by the TDMA signal generation units 11 may include a series of “0s” or an idle signal. The series of “0s” and the idle signal indicate no signals. The idle signal is, for example, a signal having alternate “1s” and “0s”. Typically, the TDMA signal generation units 11 and the optical transmitters 13 are alternating current (AC)-coupled using capacitors. In view of this, the electrical-signal packet signal typically has a DC-balanced idle signal inserted therein in order to avoid direct current (DC) drifts. In this case, the optical transmitters 13 also acquire, via another signal line, a gate signal indicating which portion is the intermittent signal portion and which portion is the idle signal. The gate signal may be transmitted from the TDMA signal generation units 11 to the optical transmitters 13, or may be transmitted from the controller 100 that controls the entire optical communication system 200 to the optical transmitters 13.

The optical transmitters 13-1 to 13-MN convert the electrical-signal packet signals acquired from the TDMA signal generation unit 11, into optical-signal packet signals, and transmit the optical-signal packet signals to a fiber-optic network, that is, the optical couplers 20. For example, the optical transmitters 13-1 to 13-M convert the electrical-signal packet signals received from the TDMA signal generation unit 11-1, into optical-signal packet signals and transmit the optical-signal packet signals to the fiber-optic network. The optical transmitters 13-1 to 13-MN each emit light providing an optical signal only in a time region of the electrical-signal packet signal received from the TDMA signal generation units 11, and undergoes a transition to a non-light-emitting state in the other time regions so as not to interfere with signals from the other optical transmitters 13.

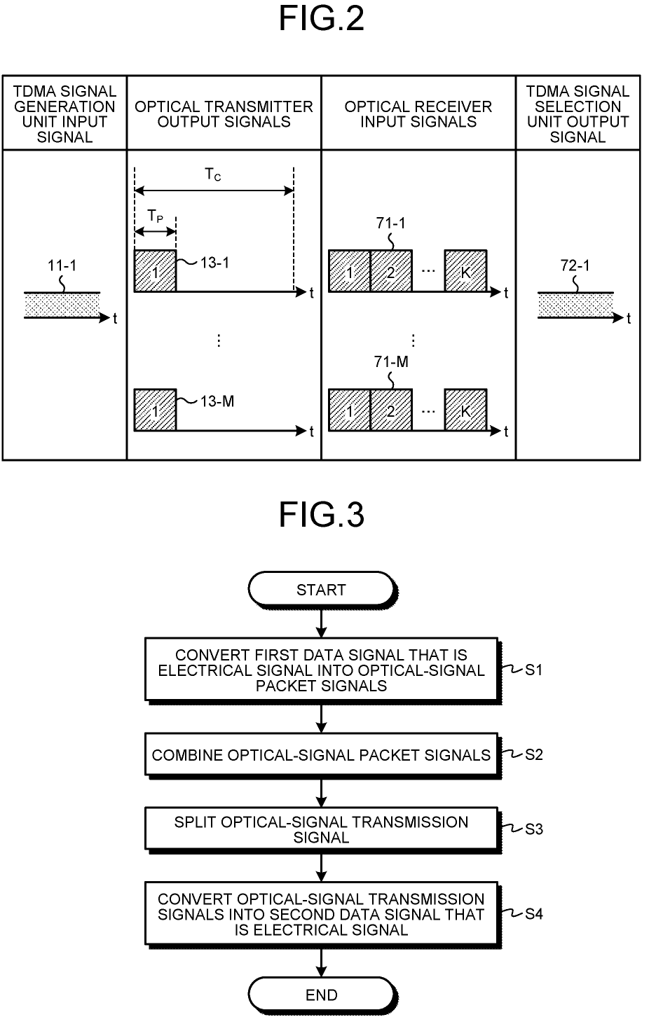

FIG. 2 is a diagram illustrating an example of signals transmitted in the optical communication system 200 according to the first embodiment. FIG. 2 also illustrates the sequence of the operations of the optical communication system 200 according to the first embodiment. The first data signal, which is an input signal to each TDMA signal generation unit 11, is a continuous signal with a constant voltage amplitude. Each TDMA signal generation unit 11 cuts off a signal on a per time-region or signal block-region basis, packetizes the signal for transmission to the optical transmitters 13, and increases the transmission speed. FIG. 2 illustrates cutting off in a time region with emphasis on clarity. For example, the TDMA signal generation unit 11-1 cuts the first data signal, which is an input signal, in a time region T_{c}. Assume that signals cut off in the time region T_{c} are all directed to a certain destination, for example, to the TDMA signal selection unit 72-1. Thereafter, the TDMA signal generation unit 11-1 divides the signal cut off in the time region T_{c}, into M pieces so as to prevent an excessive increase in output transmission speed at each optical transmitter 13. For example, when T_{c}=1 [msec] and M=8, the TDMA signal generation unit 11 divides the signal every ⅛ [msec], i.e., 0.125 [msec].

The TDMA signal generation unit 11-1 speeds up, that is, compresses the divided signals in the sense of time domain, so as to avoid their collisions in the time domain with signals from the other TDMA signal generation units 11. For example, the number of the parallel TDMA signal generation units 11 connected to the same optical fiber line is two, i.e., K=2, and an optical switch device employs non-blocking processing, in which case a signal time width Tₚ per optical transmitter 13 is ½ [msec], i.e., 0.5 [msec]. When the number of input ports for multiplexing on the same optical fiber line is more than two, the collision is avoidable even with the signal time width Tₚ longer than 0.5 [msec] provided that the number of ports to switch simultaneously is small. In FIG. 2, the signal time widths Tₚ of the signals transmitted to the optical transmitters 13 connected to the single TDMA signal generation unit 11 are all the same with the same timing. However, different signal time widths Tₚ and different signal timings may be set to prevent the signals from colliding with signals from the other TDMA signal generation units 11 in the fiber-optic network.

The optical transmitters 13 convert, into optical-signal packet signals, the electrical-signal packet signals transmitted with transmission timing determined by the TDMA signal generation units 11. The optical transmitters 13 output the optical-signal packet signals to the connected optical couplers 20. In FIG. 2, optical transmitter output signals of the optical transmitters 13-1 to 13-M are all denoted as “1” that indicates the signals are received from the TDMA signal generation unit 11-1. The contents of the packets shown in parallel are all different. For example, the optical-signal packet signal output from the optical transmitter 13-1 indicates a signal in a relative time from 0 [msec] to 0.125 [msec] of the signal input to the TDMA signal generation unit 11-1, and the optical-signal packet signal output from the optical transmitter 13-2 indicates a signal in a relative time from 0.125 [msec] to 0.25 [msec] of the signal input to the TDMA signal generation unit 11-1.

Each of the optical couplers 20-1 to 20-LM acquires the optical-signal packet signals from K optical transmitters 13 connected thereto, and combines these acquired signals together. The optical couplers 20-1 to 20-LM each split the thus combined optical-signal packet signal into N optical-signal transmission signals of the same information, and output each of the optical-signal transmission signals to a corresponding one of the optical receivers 71 of each optical receiving apparatus 70. That is, each optical coupler outputs the optical-signal transmission signals to the N optical receivers 71 in one-to-one correspondence. As illustrated in FIG. 1, each of the optical couplers 20-1 to 20-LM has K input ports and N output ports. K is an integer greater than or equal to two and smaller than N. With the range of K thus set, the optical communication system 200 can reduce the number of input ports of the optical couplers 20 to improve line efficiency. Optical receiver input signals illustrated in FIG. 2 indicate the optical-signal transmission signals combined together by the optical couplers 20 and received by the optical receivers 71 connected to the TDMA signal selection unit 72. The optical couplers 20-1 to 20-LM each combine the acquired optical-signal packet signals together, split the thus combined optical-signal packet signal into N optical-signal transmission signals, and transmit in one-to-one correspondence the N optical-signal transmission signals to the N optical receivers 71. For this reason, the optical-signal transmission signals acquired by the optical receivers 71-1 to 71-LM connected to the TDMA signal selection unit 72-1 are also acquired by the LM optical receivers 71 connected to each of the TDMA signal selection units 72-2 to 72-N. For example, the optical-signal transmission signal acquired by the optical receiver 71-1 is also acquired by the first optical receiver 71-(LM+1) connected to the TDMA signal selection unit 72-2, the first optical receiver 71-(LM2+1) connected to the TDMA signal selection unit 72-3, etc. The optical-signal transmission signal acquired by the optical receiver 71-M is also acquired by the Mth optical receiver 71-(LM+M) connected to the TDMA signal selection unit 72-2, the Mth optical receiver 71-(LM2+M) connected to the TDMA signal selection unit 72-3, etc.

According to the example described above, the optical receiver input signals illustrated in FIG. 2 includes the optical-signal transmission signal illustrated in the uppermost row. The optical-signal transmission signal includes a portion “1” indicating a signal in a relative time from 0 [msec] to 0.125 [msec] of the signal input to the TDMA signal generation unit 11-1, a portion “2” indicating a signal in a relative time from 0 [msec] to 0.125 [msec] of the signal input to the TDMA signal generation unit 11-2,..., and a portion “K” indicating a signal in a relative time from 0 [msec] to 0.125 [msec] of the signal input to the TDMA signal generation unit 11 K. These portions define a signal of 1 [msec] in total. Although not illustrated in FIG. 2, the optical-signal transmission signal to come next to the optical-signal transmission signal illustrated in the uppermost row in the optical receiver input signals illustrated in FIG. 2 is a signal in a relative time from 0.125 [msec] to 0.25 [msec] of the signals input to the TDMA signal generation units 11-1 to 11-K. In the optical communication system 200, the N TDMA signal selection units 72 receive the optical-signal packet signals transmitted from the MN optical transmitters 13 connected to the N TDMA signal generation units 11 via the LM optical receivers 71, thereby allowing the reconstruction of the signals in the relative time from 0 [msec] to 1 [msec], and TDMA signal selection, that is, the selection of a second data signal that is an electrical signal. Although all the packet signals have the same signal time width Tₚ in the example of FIG. 2, each TDMA signal generation unit 11 may use packets of a different signal time width T_{P}.

The optical receivers 71-1 to 71-LM convert the acquired optical-signal transmission signals into electrical-signal transmission signals. For optical-signal transmission signals acquired by a certain one of the optical receivers 71, different losses in transmission paths from the optical transmitters 13 to the optical receiver 71, different output optical powers of the optical transmitters 13, etc. cause a difference in optical level between the optical-signal transmission signals. These optical level differences is removable without changing the photoelectric conversion gain of the optical receiver 71. In other words, the optical-signal transmission signals of different optical levels can be converted into signals of a constant voltage amplitude. In some case, however, the photoelectric conversion gain for each optical-signal transmission signal needs changing depending on the switch configuration. Further, it is difficult for the receiving end to exactly synchronize the phases of the optical-signal packet signals from the different optical transmitters 13. For this reason, relative phases, for example, the phases of rising edges and falling edges when non-return-to-zero (NRZ) signals are used are typically different. In this case, the state of the optical receiver 71 is required to be optimized on a per optical-transmission-signal basis to remove the optical level difference, the phase differences, etc. without the occurrence of signal losses. For this purpose, each optical-signal transmission signal has a preamble pattern inserted in the packet head. For example, International Telecommunication Union (ITU)-TG.9807.1, which provides for a 10 Gbps-class system, 10 \-Gigabit-capable symmetric passive optical network (XGS-PON), stipulates that the preamble length is 128.6 ns to 610.9 ns. A proper preamble pattern can be inserted according to the system configuration. The longer preamble length provides the more relaxed optimization time required of the optical transmitters 13 and the optical receivers 71 while the improvement of the transmission speed, the time compression ratio, etc. is required to maintain desired switching capability.

The TDMA signal selection units 72 acquire the electrical-signal transmission signals from the optical receivers 71 connected thereto. On the basis of routing information included in a second control signal acquired from the controller 100, each TDMA signal selection unit 72 selects signals in a specified time slot from the received electrical-signal transmission signals, and outputs the selected time-slot signals as a second data signal that is an electrical signal. Specifically, each TDMA signal selection unit 72 extracts only a necessary destination on the basis of the routing information, and discards the other signals. Each TDMA signal selection unit 72 converts the temporally intermittent extracted signals into a temporally continuous signal, and changes the transmission speed in conformity with the following system connected thereto before transmitting the continuous signal. A TDMA signal selection unit output signal illustrated in FIG. 2 indicates the second data signal output from the TDMA signal selection unit 72-1 by way of example.

The controller 100 generates control information necessary for the TDMA signal generation units 11 and the TDMA signal selection units 72 to perform the above-described control, a reference clock for the entire optical communication system 200 to operate in synchronization, etc., and provides those to each unit. The controller 100 generates and distributes a first control signal: The controller 100 generates a reference clock, a transmission timing signal as a communication resource allocation, and routing information, and distributes those to the TDMA signal generation units 11-1 to 11-N. The controller 100 distributes a second control signal: The controller 100 distributes a transmission timing signal as a communication resource allocation, and routing information to the TDMA signal selection units 72-1 to 72-N. Although not illustrated in FIGS. 1 and 2, the controller 100 may provide the optical transmitters 13 and the optical receivers 71 with other necessary control signals, for example, a state transition signal or the like for the optical transmitters 13. FIG. 1 only illustrates lines on which to supply the control information from the controller 100 to the TDMA signal generation units 11 and the TDMA signal selection units 72, which is not limiting. The controller 100 may acquire state information, for example, failure information from each component as necessary, and, on the basis of the state information on each component, change the allocations, destinations, etc. of packet signals.

As described above, the optical communication system 200 in the present embodiment includes: the plurality of optical transmitting apparatuses 10-1 to 10-N, each of which converts a first data signal that is an electrical signal into a plurality of optical-signal packet signals and transmits the plurality of optical-signal packet signals; and the plurality of optical couplers 20-1 to 20-LM, each of which combines optical-signal packet signals transmitted from fewer than all of the plurality of optical transmitting apparatuses 10-1 to 10-N, the fewer optical transmitting apparatuses 10 being different from each other, splits the combined optical-signal packet signals into a plurality of optical-signal transmission signals of the same information, and outputs the plurality of optical-signal transmission signals. Further, the optical communication system 200 includes: the plurality of optical receiving apparatuses 70-1 to 70-N, each of which receives optical-signal transmission signals from the plurality of optical couplers 20-1 to 20-LM, the received optical-signal transmission signals each being one of the separate optical-signal transmission signals provided by the corresponding one of the plurality of optical couplers 20-1 to 20-LM, converts the received optical-signal transmission signals into a second data signal that is an electrical signal, and outputs the second data signal; and the controller 100 that controls the operation of the plurality of optical transmitting apparatuses 10-1 to 10-N and the plurality of optical receiving apparatuses 70-1 to 70-N. The number of signals combined by the optical couplers 20-1 to 20-LM is smaller than the number of the plurality of optical transmitting apparatuses 10-1 to 10-N. On the basis of the first control signal acquired from the controller 100, each optical transmitting apparatus 10 transmits a plurality of optical-signal packet signals, allocating communication resources thereto in such a manner as to prevent the transmitted optical-signal packet signals from colliding with optical-signal packet signals transmitted from the other optical transmitting apparatuses 10. Each optical receiving apparatus 70 converts optical-signal transmission signals into electrical-signal transmission signals, and, on the basis of the second control signal acquired from the controller 100, selects specified signal portions from the electrical-signal transmission signals and outputs the selected signal portions as the second data signal.

The operation of the optical communication system 200 will be described with reference to a flowchart. FIG. 3 is a flowchart illustrating the operation of the optical communication system 200 according to the first embodiment. Under the control of the controller 100, each of the optical transmitting apparatuses 10-1 to 10-N converts the first data signal that is an electrical signal into optical-signal packet signals, and transmits the optical-signal packet signals (step S1). At this time, on the basis of the first control signal acquired from the controller 100, each optical transmitting apparatus 10 transmits the optical-signal packet signals, allocating communication resources thereto in such a manner as to prevent the transmitted optical-signal packet signals from colliding with optical-signal packet signals transmitted from the other optical transmitting apparatuses 10. The optical couplers 20-1 to 20-LM each combine optical-signal packet signals received from the optical transmitting apparatuses 10-1 to 10-N (step S2), split a combined optical-signal transmission signal into a plurality of optical-signal transmission signals of the same information, and output the plurality of optical-signal transmission signals (step S3). Under the control of the controller 100, each of the optical receiving apparatuses 70-1 to 70-N receives the separate optical-signal transmission signals provided by the optical couplers 20-1 to 20-LM, converts the optical-signal transmission signals into the second data signal that is an electrical signal, and outputs the second data signal (step S4). At this time, each optical receiving apparatus 70 converts the optical-signal transmission signals into electrical-signal transmission signals, and, on the basis of the second control signal acquired from the controller 100, selects specified signal portions from the electrical-signal transmission signals and outputs the selected signal portions as the second data signal. The controller 100 in the optical communication system 200 controls the operation of the optical transmitting apparatuses 10-1 to 10-N and the optical receiving apparatuses 70-1 to 70-N.

Specifically, in the present embodiment, on the basis of the first control signal, the optical transmitting apparatuses 10-1 to 10-N transmit optical-signal packet signals, allocating time slots thereto in such a manner as to prevent the transmitted optical-signal packet signals from colliding with optical-signal packet signals transmitted from the other optical transmitting apparatuses 10. On the basis of the second control signal, the optical receiving apparatuses 70-1 to 70-N select signals in a specified time slot from electrical-signal transmission signals, and output the selected signals as the second data signal.

Next, a hardware configuration of the optical communication system 200 will be described. In the optical communication system 200, the optical transmitters 13 and the optical receivers 71 are photoelectric conversion circuits. The optical couplers 20 are power splitters as described above. The TDMA signal generation units 11, the TDMA signal selection units 72, and the controller 100 are implemented by processing circuitry. The processing circuitry may be a processor that executes a program stored in memory and the memory, or may be dedicated hardware. The processing circuitry is also referred to as a control circuit.

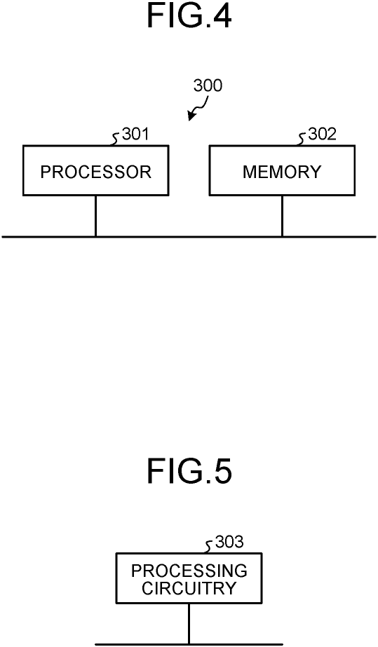

FIG. 4 is a diagram illustrating a configuration example of processing circuitry 300 when a processor and memory implement processing circuitry included in the optical communication system 200 according to the first embodiment. The processing circuitry 300 illustrated in FIG. 4 is a control circuit, and includes a processor 301 and memory 302. When the processor 301 and the memory 302 constitute the processing circuitry 300, the functions of the processing circuitry 300 are implemented by software, firmware, or a combination of software and firmware. The software or firmware is described as a program and stored in the memory 302. In the processing circuitry 300, the processor 301 reads and executes the program stored in the memory 302, thereby implementing each function. That is, the processing circuitry 300 includes the memory 302 for storing the program that results in the execution of processing in the optical communication system 200. This program can be said to be a program for causing the optical communication system 200 to perform each function implemented by the processing circuitry 300. This program may be provided by a storage medium in which the program is stored, or may be provided by another means such as a communication medium.

The program can be said to be a program for the controller 100 to cause each optical transmitting apparatus 10 to, based on the first control signal acquired from the controller 100, allocate communication resources so as to avoid collisions with optical-signal packet signals transmitted from the other optical transmitting apparatuses 10, and transmit a plurality of optical-signal packet signals, and cause each optical receiving apparatus 70 to convert optical-signal transmission signals into electrical-signal transmission signals, and, based on the second control signal acquired from the controller 100, select specified signal portions from the electrical-signal transmission signals and output the selected signal portions as the second data signal.

Here, the processor 301 is, for example, a central processing unit (CPU), a processing unit, an arithmetic unit, a microprocessor, a microcomputer, a digital signal processor (DSP), or the like. The memory 302 corresponds, for example, to nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disk, a mini disk, a digital versatile disc (DVD), or the like.

FIG. 5 is a diagram illustrating an example of processing circuitry 303 when dedicated hardware constitutes the processing circuitry included in the optical communication system 200 according to the first embodiment. The processing circuitry 303 illustrated in FIG. 5 corresponds, for example, to a single circuit, a combined circuit, a programmed processor, a parallel-programmed processor, an application-specific integrated circuit (ASIC), a field-programmable gate array (FPGA), or a combination of them. The processing circuitry may be implemented partly by dedicated hardware and partly by software or firmware. Thus, the processing circuitry can implement the above-described functions by dedicated hardware, software, firmware, or a combination of them.

As described above, according to the present embodiment, by controlling transmission timing for the TDMA signal generation unit 11 of each optical transmitting apparatus 10 using TDMA, the optical communication system 200 can configure matrix switch connections only with passive components of the optical couplers 20, without using optical switches in the optical region, and thus can improve reliability. Furthermore, by limiting the number of signals combined by the optical couplers 20, the optical communication system 200 can limit the number of packets combined by each the optical coupler 20, and thus can improve line efficiency.

Optical switches, which are, for example, Mach-Zehnder interferometers, are larger in power consumption, cost, size, and weight per switch port than electrical switches made up of an ASIC, etc., and require a long switching time of some 10 us from the determination of path switching information to switching. By contrast, the optical communication system 200 does not use optical switches, and thus can achieve lower power consumption, space saving, weight reduction, cost reduction, and path switching time reduction.

### Second Embodiment

In the first embodiment, each optical receiving apparatus 70 includes the same number of the optical receivers 71 as that of the optical couplers 20. A second embodiment describes each optical transmitting apparatus 10 including the same number of the optical transmitters 13 as that of the optical couplers 20.

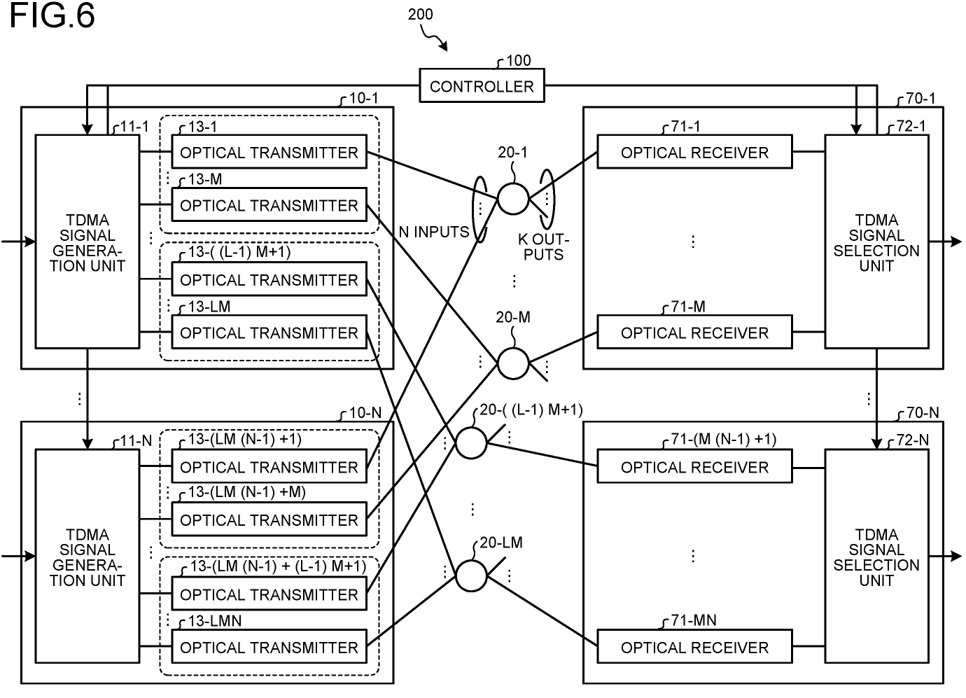

FIG. 6 is a diagram illustrating an example configuration of the optical communication system 200 according to the second embodiment. The optical communication system 200 illustrated in FIG. 6 includes N input ports and N output ports (not illustrated), and performs switching between the N input ports and the N output ports by TDMA. The optical communication system 200 includes the TDMA signal generation units 11-1 to 11-N, the optical transmitters 13-1 to 13-LMN, the optical couplers 20-1 to 20-LM, the optical receivers 71-1 to 71-MN, the TDMA signal selection units 72-1 to 72-N, and the controller 100. L, M, and N are integers greater than or equal to two. L<N holds true. As in the first embodiment, K described later is an integer greater than or equal to two and smaller than N.

In the optical communication system 200, the TDMA signal generation unit 11-1 and the optical transmitters 13-1 to 13-LM define the optical transmitting apparatus 10-1, the TDMA signal generation unit 11-2 and the optical transmitters 13-(LM+1) to 13-LM2 define the optical transmitting apparatus 10-2, ..., and the TDMA signal generation unit 11-N and the optical transmitters 13-(LM(N-1)+1) to 13-LMN define the optical transmitting apparatus 10-N. The optical receivers 71-1 to 71-M and the TDMA signal selection unit 72-1 define the optical receiving apparatus 70-1, the optical receivers 71-(M+1) to 71-M2 and the TDMA signal selection unit 72-2 define the optical receiving apparatus 70-2, ..., and the optical receivers 71-(M(N-1)+1) to 71-MN and the TDMA signal selection unit 72-N define the optical receiving apparatus 70-N. The optical couplers 20-1 to 20-LM are, for example, power splitters.

In the following description, the optical transmitting apparatuses 10-1 to 10-N are sometimes referred to as the optical transmitting apparatuses 10 when not distinguished, the TDMA signal generation units 11-1 to 11-N are sometimes referred to as the TDMA signal generation units 11 when not distinguished, and the optical transmitters 13-1 to 13-LMN are sometimes referred to as the optical transmitters 13 when not distinguished. The optical couplers 20-1 to 20-LM are sometimes referred to as the optical couplers 20 when not distinguished. The optical receiving apparatuses 70-1 to 70-N are sometimes referred to as the optical receiving apparatuses 70 when not distinguished, the optical receivers 71-1 to 71-MN are sometimes referred to as the optical receivers 71 when not distinguished, and the TDMA signal selection units 72-1 to 72-N are sometimes referred to as the TDMA signal selection units 72 when not distinguished.

In the present embodiment, each of the optical couplers 20-1 to 20-LM combines optical-signal packet signals each transmitted from one of the optical transmitters 13 of the corresponding optical transmitting apparatus 10. That is, each of the optical couplers 20-1 to 20-LM combines optical-signal packet signals transmitted from N optical transmitters 13. The optical couplers 20-1 to 20-LM split the combined optical-signal packet signals into K optical-signal transmission signals of the same information, and output the K optical-signal transmission signals to K the optical receivers 71 connected thereto. As illustrated in FIG. 6, the optical couplers 20-1 to 20-LM each have N input ports and K output ports. Thus, in the second embodiment, compared to the first embodiment, the number of the optical transmitters 13 connected to each TDMA signal generation unit 11 is increased to LM, while the number of the optical receivers 71 connected to each TDMA signal selection unit 72 is reduced to M. As a result, the total number of the optical transmitters 13 and the optical receivers 71 is the same between the first embodiment and the second embodiment. Although the first embodiment and the second embodiment are different from each other in the number of signals combined together and the number of separated signals in the optical couplers 20-1 to 20-LM, the first embodiment and the second embodiment are the same in the total number of the signals combined together and the separated signals.

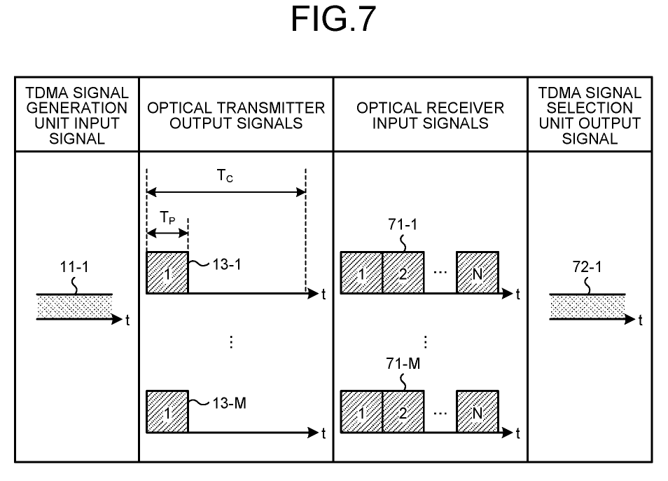

FIG. 7 is a diagram illustrating an example of signals transmitted in the optical communication system 200 according to the second embodiment. FIG. 7 also illustrates the sequence of the operations of the optical communication system 200 according to the second embodiment. As in the first embodiment, each TDMA signal generation unit 11 temporally divides first data that is an input signal to change the first data signal into temporally intermittent electrical-signal packet signals. In the second embodiment, the number of the output ports of the optical couplers 20-1 to 20-LM is limited. For this reason, for example, the TDMA signal generation unit 11-1 duplicates the electrical-signal packet signal and transmits the same electrical-signal packet signals to L optical transmitters 13, that is, to one optical transmitter for every M optical transmitters 13 of the connected optical transmitters 13-1 to 13-LM. The other operation in the TDMA signal generation units 11 is the same as that of the TDMA signal generation units 11 of the first embodiment. A TDMA signal generation unit input signal illustrated in FIG. 7 indicates a first data signal that is a signal input to the TDMA signal generation unit 11-1, by way of example.

The optical transmitters 13 convert, into optical-signal packet signals, the electrical-signal packet signals transmitted with transmission timing determined by the TDMA signal generation units 11. The optical transmitters 13 output the optical-signal packet signals to the optical couplers 20 connected thereto. As indicated by optical transmitter output signals of FIG. 7, the optical-signal packet signals output from the optical transmitters 13-1, 13-(M+1), 13-(2M+1), ..., and 13-((L-1)M+1) connected to the TDMA signal generation unit 11-1 are the same signal. Likewise, the optical-signal packet signals output from the optical transmitters 13-M, 13-2M, 13-3M, ..., and 13-LM connected to the TDMA signal generation unit 11-1 are the same signal.

As described above, each of the optical couplers 20-1 to 20-LM combines the optical-signal packet signals each transmitted from one of the optical transmitters 13 of the corresponding optical transmitting apparatus 10. That is, each of the optical couplers 20-1 to 20-LM combines the optical-signal packet signals transmitted from N optical transmitters 13. The optical couplers 20-1 to 20-LM split the combined optical-signal packet signals into K optical-signal transmission signals of the same information, and output the K optical-signal transmission signals to K optical receivers 71 connected thereto.

Each optical receiver 71 acquires, from the corresponding one of the optical couplers 20, the optical-signal transmission signal defined by the N optical-signal packet signals combined together. That is, each optical receiver 71 can acquire the signals output from all the TDMA signal generation units 11. It therefore follows that the signal time width Tₚ of the signal output from each TDMA signal generation unit 11 included in each optical-signal transmission signal is obtained by division of Tc by the number of the packet signals from all the TDMA signal generation units 11. For example, when packet signals of the same time width are transmitted from all the TDMA signal generation units 11, the signal time width Tₚ is T_{c}/N, or Tₚ=T_{c}/N. Optical receiver input signals of FIG. 7 specifically indicate the optical-signal transmission signals acquired by the optical receivers 71-1 and 71-M.

As in the first embodiment, on the basis of routing information included in a second control signal acquired from the controller 100, each TDMA signal selection unit 72 selects the signals in a specified time slot from the electrical-signal transmission signals received from the connected optical receivers 71, and outputs the selected time-slot signals as a second data signal that is an electrical signal. Specifically, each TDMA signal selection unit 72 extracts only a necessary destination on the basis of the routing information, and discards the other signals. Each TDMA signal selection unit 72 converts the temporally intermittent extracted signals into a temporally continuous signal, and changes the transmission speed in conformity with the following system connected thereto before transmitting the continuous signal. A TDMA signal selection unit output signal illustrated in FIG. 7 indicates the second data signal output from the TDMA signal selection unit 72-1, by way of example.

The operation other than the operation of each component described in the present embodiment is the same as the operation of each component described in the first embodiment.

As described above, in the present embodiment, the optical communication system 200 includes: the plurality of optical transmitting apparatuses 10-1 to 10-N, each of which converts the first data signal that is an electrical signal into a plurality of optical-signal packet signals and transmits the plurality of optical-signal packet signals; and the plurality of optical couplers 20-1 to 20-LM, each of which combines optical-signal packet signals transmitted in one-to-one correspondence from the plurality of optical transmitting apparatuses 10-1 to 10-N, splits the combined optical-signal packet signals into a plurality of optical-signal transmission signals of the same information, and outputs the plurality of optical-signal transmission signals. Further, the optical communication system 200 includes: the plurality of optical receiving apparatuses 70-1 to 70-N, each of which receives optical-signal transmission signals from fewer than all of the plurality of optical couplers 20-1 to 20-LM, the received optical-signal transmission signals each being one of the separate optical-signal transmission signals provided by the corresponding one of the fewer optical couplers 20, converts the received optical-signal transmission signals into a second data signal that is an electrical signal, and outputs the second data signal; and the controller 100 that controls the operation of the plurality of optical transmitting apparatuses 10-1 to 10-N and the plurality of optical receiving apparatuses 70-1 to 70-N. The number of the separate optical-signal transmission signals provided by each of the optical couplers 20-1 to 20-LM is smaller than the number of the plurality of optical receiving apparatuses 70-1 to 70-N. On the basis of the first control signal acquired from the controller 100, each optical transmitting apparatus 10 duplicates a first data signal and transmits a plurality of optical-signal packet signals, allocating communication resources thereto by destination in such a manner as to prevent the transmitted optical-signal packet signals from colliding with optical-signal packet signals transmitted from the other optical transmitting apparatuses 10. Each optical receiving apparatus 70 converts optical-signal transmission signals into electrical-signal transmission signals, and, on the basis of the second control signal acquired from the controller 100, selects specified signal portions from the electrical-signal transmission signals and outputs the selected signal portions as the second data signal.

As described above, according to the present embodiment, by controlling transmission timing for the TDMA signal generation unit 11 of each optical transmitting apparatus 10 using TDMA, the optical communication system 200 can configure matrix switch connections only with passive components of the optical couplers 20, without using optical switches in the optical region, and thus can improve reliability. In the present embodiment, each optical coupler 20 combines signals transmitted from all the TDMA signal generation units 11. Thus, when the number of the TDMA signal generation units 11 that transmit signals is small, that is, when signals are sparse, the optical communication system 200 can improve line efficiency, compared to the first embodiment.

### Third Embodiment

The first embodiment and the second embodiment are the same in the total number of the optical transmitters 13 and the optical receivers 71. A third embodiment describes the smaller total number of the optical transmitters 13 and the optical receivers 71 than that in the first and second embodiments.

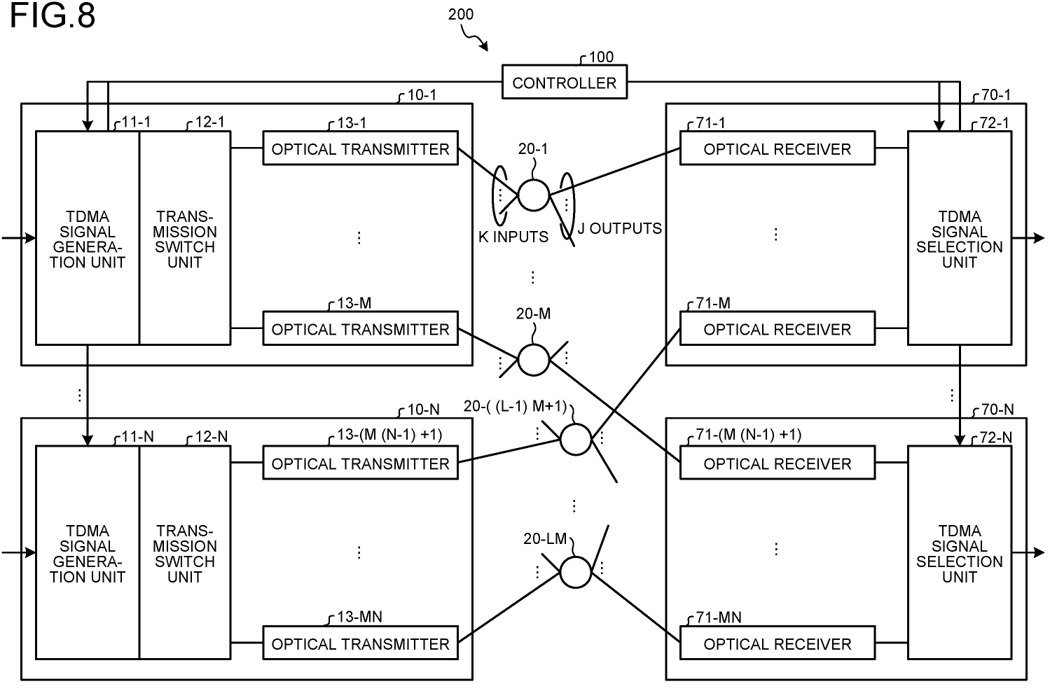

FIG. 8 is a diagram illustrating an example configuration of the optical communication system 200 according to the third embodiment. The optical communication system 200 illustrated in FIG. 8 includes N input ports and N output ports (not illustrated), and performs switching between the N input ports and the N output ports by TDMA. The optical communication system 200 includes the TDMA signal generation units 11-1 to 11-N, transmission switch units 12-1 to 12-N, the optical transmitters 13-1 to 13-MN, the optical couplers 20-1 to 20-LM, the optical receivers 71-1 to 71-MN, the TDMA signal selection units 72-1 to 72-N, and the controller 100. L, M, and N are integers greater than or equal to two.

In the optical communication system 200, the TDMA signal generation unit 11-1, the transmission switch unit 12-1, and the optical transmitters 13-1 to 13-M define the optical transmitting apparatus 10-1, the TDMA signal generation unit 11-2, the transmission switch unit 12-2, and the optical transmitters 13-(M+1) to 13-M2 define the optical transmitting apparatus 10-2,..., and the TDMA signal generation unit 11-N, the transmission switch unit 12-N, and the optical transmitters 13-(M(N-1)+1) to 13-MN define the optical transmitting apparatus 10-N. The optical receivers 71-1 to 71-M and the TDMA signal selection unit 72-1 define the optical receiving apparatus 70-1, the optical receivers 71-(M+1) to 71-M2 and the TDMA signal selection unit 72-2 define the optical receiving apparatus 70-2, ..., and the optical receivers 71-(M(N-1)+1) to 71-MN and the TDMA signal selection unit 72-N define the optical receiving apparatus 70-N. The optical couplers 20-1 to 20-LM are, for example, power splitters.

In the following description, the optical transmitting apparatuses 10-1 to 10-N are sometimes referred to as the optical transmitting apparatuses 10 when not distinguished, the TDMA signal generation units 11-1 to 11-N are sometimes referred to as the TDMA signal generation units 11 when not distinguished, the transmission switch units 12-1 to 12-N are sometimes referred to as transmission switch units 12 when not distinguished, and the optical transmitters 13-1 to 13-MN are sometimes referred to as the optical transmitters 13 when not distinguished. The optical couplers 20-1 to 20-LM are sometimes referred to as the optical couplers 20 when not distinguished. The optical receiving apparatuses 70-1 to 70-N are sometimes referred to as the optical receiving apparatuses 70 when not distinguished, the optical receivers 71-1 to 71-MN are sometimes referred to as the optical receivers 71 when not distinguished, and the TDMA signal selection units 72-1 to 72-N are sometimes referred to as the TDMA signal selection units 72 when not distinguished.

In the present embodiment, each of the optical couplers 20-1 to 20-LM combines optical-signal packet signals transmitted from K of the optical transmitters 13. The optical couplers 20-1 to 20-LM split the combined optical-signal packet signals into J optical-signal transmission signals of the same information, and output the J optical-signal transmission signals to J optical receivers 71 connected thereto. As illustrated in FIG. 8, the optical couplers 20-1 to 20-LM each have K input ports and J output ports. K and J are integers greater than or equal to two and smaller than N. K and J may be the same integer or different integers, depending on the configuration of the optical communication system 200. In the third embodiment, the number of the optical transmitters 13 connected to each TDMA signal generation unit 11 and the number of the optical receivers 71 connected to each TDMA signal selection unit 72 are both M. The total number of the optical transmitters 13 and the optical receivers 71 can be reduced, compared to that in the first and second embodiments. In the third embodiment, the number of signals combined together or the number of separated signals, whichever is greater, in the optical couplers 20-1 to 20-LM can be reduced, compared to that in the first and second embodiments, so that the loss budget can be reduced.

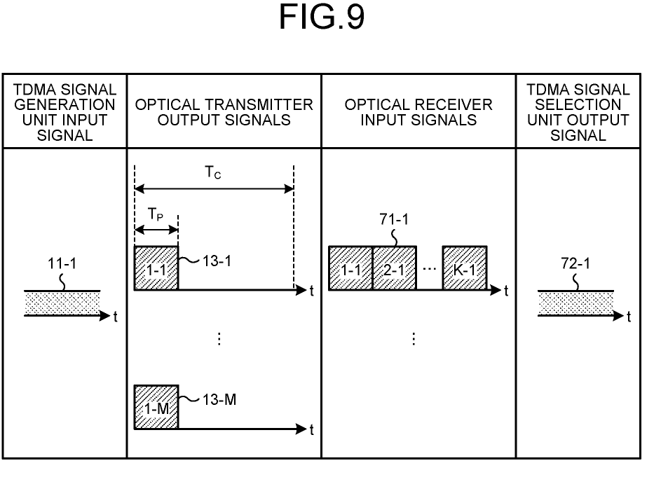

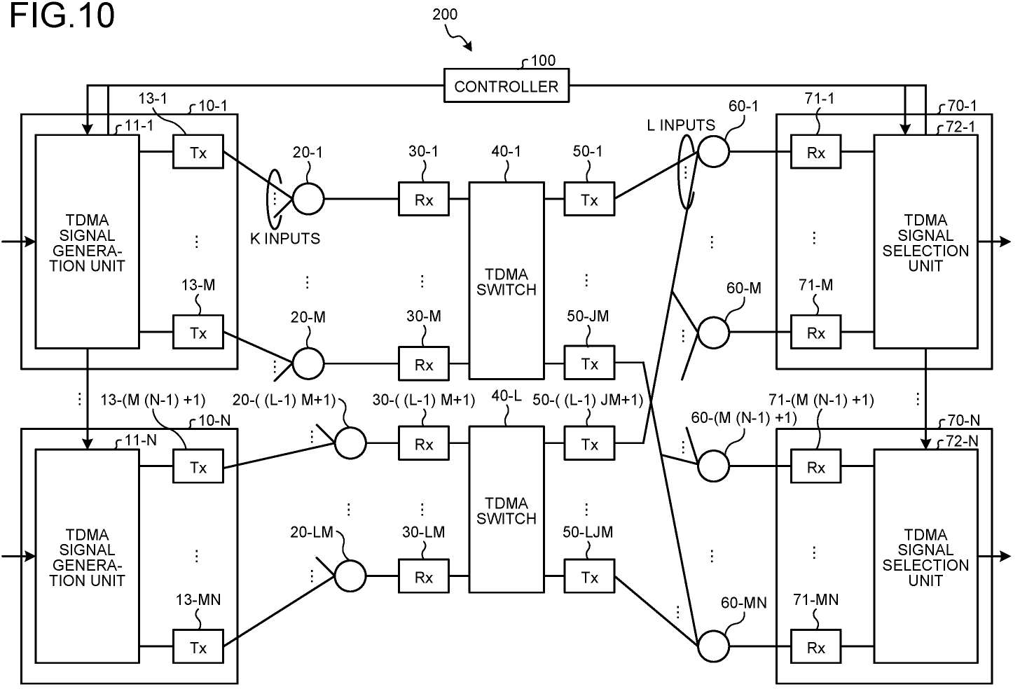

FIG. 9 is a diagram illustrating an example of signals transmitted in the optical communication system 200 according to the third embodiment. FIG. 9 also illustrates the sequence of the operations of the optical communication system 200 according to the third embodiment. As in the first embodiment etc., each TDMA signal generation unit 11 temporally divides first data signal that is an input signal to change the first data into temporally intermittent electrical-signal packet signals. A TDMA signal generation unit input signal illustrated in FIG. 9 indicates a first data signal that is a signal input to the TDMA signal generation unit 11-1, by way of example. In the present embodiment, the number of the input ports and the number of the output ports of each optical coupler 20 are limited. The different optical couplers 20 are connected via the optical receivers 71 to the different TDMA signal selection units 72. For this reason, each transmission switch unit 12 organizes the optical transmitters 13 to transmit each electrical-signal packet signal, generated by the TDMA signal generation unit 11, in accordance with the TDMA signal selection unit 72 that is a destination of that pack signal. In the example of FIG. 8, the transmission switch unit 12-1 transmits, to the optical transmitter 13-1, a signal whose destination is the TDMA signal selection unit 72-1, and transmits, to the optical transmitter 13-M, a signal whose destination is the TDMA signal selection unit 72-N. This is how the transmission switch unit 12 of each optical transmitting apparatus 10 switches in advance the optical transmitter 13 to which to transmit a signal. This allows the optical communication system 200 to perform switching from a certain input port to a desired output port, even when the numbers of the input and output ports of the optical couplers 20 are limited.

In FIG. 9, optical transmitter output signals indicate output signals from the optical transmitter 13-1 and the optical transmitter 13-M that have acquired signals from the TDMA signal generation unit 11-1 as a result of switching by the transmission switch unit 12-1. Although the example of FIG. 9 is where the signal time widths Tₚ of the optical-signal packet signals transmitted from the optical transmitters 13-1 and 13-M are the same, the signal time widths T_{P} of optical-signal packet signals transmitted from the optical transmitters 13 may be different because the signal time widths T_{P} may vary from destination to destination.

FIG. 9 illustrates an optical receiver input signal, taking an example of an optical-signal transmission signal received by the optical receiver 71-1 connected to the TDMA signal selection unit 72-1. The optical receiver 71-1 acquires, from the optical coupler 20-1, the optical-signal transmission signal into which the optical-signal packet signals from the optical transmitters 13-1, 13-(M+1), ..., and 13-((K-1)M+1) are combined. The optical-signal packet signal from the optical transmitter 13-1 is based on the electrical-signal packet signal transmitted from the TDMA signal generation unit 11-1, the optical-signal packet signal from the optical transmitter 13-(M+1) is based on the electrical-signal packet signal transmitted from the TDMA signal generation unit 11-2,..., and the optical-signal packet signal from the optical transmitter 13-((K-1)M+1) is based on the electrical-signal packet signal transmitted from the TDMA signal generation unit 11-K. The optical transmitting apparatuses 10-1 to 10-K are illustrated as being connected to the optical coupler 20-1, by way of example, which is not limiting. In another example, the destinations of signals generated by the TDMA signal generation unit 11-2 of the optical transmitting apparatus 10-2 will never be the TDMA signal selection unit 72-1, in which case the optical transmitting apparatuses 10 connected to the optical coupler 20-1 may be the optical transmitting apparatuses 10-1 and 10-3 to 10-(K+1).

The example illustrated in FIG. 9 is where optical-signal packet signals are input to each optical coupler 20 from all of the K optical transmitters 13. In another example, optical-signal packet signals are input from a limited number of the optical transmitters 13 to each optical coupler 20, in which case the optical-signal packet signals may be spaced apart, or the signal time width T_{P} may be increased. The optical receivers 71 convert the acquired optical-signal transmission signals into electrical-signal transmission signals and output the electrical-signal transmission signals to the TDMA signal selection units 72.

As in the first embodiment, on the basis of routing information included in a second control signal acquired from the controller 100, each TDMA signal selection unit 72 selects the signals in a specified time slot from the electrical-signal transmission signals received from the connected optical receivers 71, and outputs the selected time-slot signals as a second data signal that is an electrical signal. Specifically, each TDMA signal selection unit 72 extracts only a necessary destination on the basis of the routing information, and discards the other signals. Each TDMA signal selection unit 72 converts the temporally intermittent extracted signals into a temporally continuous signal, and changes the transmission speed in conformity with the following system connected thereto before transmitting the continuous signal. A TDMA signal selection unit output signal illustrated in FIG. 9 indicates the second data signal output from the TDMA signal selection unit 72-1, by way of example.

The operation other than the operation of each component described in the present embodiment is the same as the operation of each component described in the first embodiment.

As described above, in the present embodiment, the optical communication system 200 includes: the plurality of optical transmitting apparatuses 10-1 to 10-N, each of which converts a first data signal that is an electrical signal into a plurality of optical-signal packet signals and transmits the plurality of optical-signal packet signals; and the plurality of optical couplers 20-1 to 20-LM, each of which combines optical-signal packet signals transmitted from fewer than all of the plurality of optical transmitting apparatuses 10-1 to 10-N, the fewer optical transmitting apparatuses being different from each other, splits the combined optical-signal packet signals into a plurality of optical-signal transmission signals of the same information, and outputs the plurality of optical-signal transmission signals. Further, the optical communication system 200 includes: the plurality of optical receiving apparatuses 70-1 to 70-N, each of which receives optical-signal transmission signals from fewer than all of the plurality of optical couplers 20-1 to 20-LM, the received optical-signal transmission signals each being one of the separate optical-signal transmission signals provided by the corresponding one of the fewer optical couplers 20, converts the received optical-signal transmission signals into a second data signal that is an electrical signal, and outputs the second data signal; and the controller 100 that controls the operation of the plurality of optical transmitting apparatuses 10-1 to 10-N and the plurality of optical receiving apparatuses 70-1 to 70-N. The number of signals combined by each of the optical couplers 20-1 to 20-LM is smaller than the number of the plurality of optical transmitting apparatuses 10-1 to 10-N. The number of the separate optical-signal transmission signals provided by each of the optical couplers 20-1 to 20-LM is smaller than the number of the plurality of optical receiving apparatuses 70-1 to 70-N. On the basis of the first control signal acquired from the controller 100, each optical transmitting apparatus 10 switches between the optical couplers 20 by destination, and transmits optical-signal packet signals, allocating communication resources thereto by destination in such a manner as to prevent the transmitted optical-signal packet signals from colliding with optical-signal packet signals transmitted from the other optical transmitting apparatuses 10. Each optical receiving apparatus 70 converts optical-signal transmission signals into electrical-signal transmission signals, and, on the basis of the second control signal acquired from the controller 100, selects specified signal portions from the electrical-signal transmission signals and outputs the selected signal portions as the second data signal.

A hardware configuration of the optical communication system 200 will be described. In the optical communication system 200, the transmission switch units 12 are implemented by processing circuitry. The processing circuitry may be a processor that executes a program stored in memory and the memory, or may be dedicated hardware.

As described above, according to the present embodiment, by controlling transmission timing for the TDMA signal generation unit 11 of each optical transmitting apparatus 10 using TDMA, the optical communication system 200 can configure matrix switch connections only with passive components of the optical couplers 20, without using optical switches in the optical region, and thus can improve reliability. Furthermore, by limiting the number of signals combined by and the number of separate signals provided by the optical couplers 20, the optical communication system 200 can reduce the losses of the optical couplers 20. Compared to the first and second embodiments, the present embodiment can reduce the loss budget and can reduce the total number of the optical transmitters 13 and the optical receivers 71.

### Fourth Embodiment

A fourth embodiment describes the optical communication system 200 including TDMA switches that switch electrical signals.

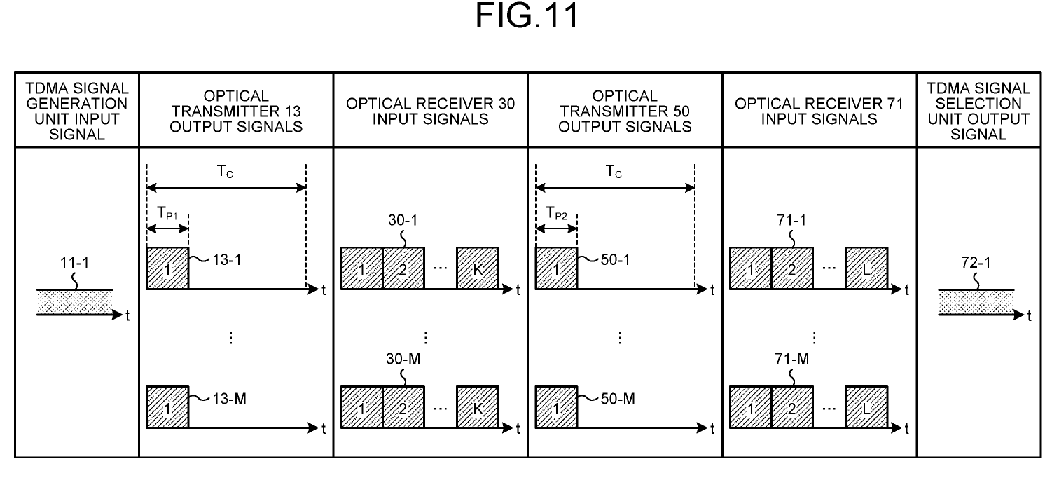

FIG. 10 is a diagram illustrating an example configuration of the optical communication system 200 according to the fourth embodiment. The optical communication system 200 illustrated in FIG. 10 includes N input ports and N output ports (not illustrated), and performs switching between the N input ports and the N output ports by TDMA. The optical communication system 200 includes the TDMA signal generation units 11-1 to 11-N, the optical transmitters 13-1 to 13-MN, the optical couplers 20-1 to 20-LM, optical receivers 30-1 to 30-LM, TDMA switches 40-1 to 40-L, optical transmitters 50-1 to 50-LJM, optical couplers 60-1 to 60-MN, the optical receivers 71-1 to 71-MN, the TDMA signal selection units 72-1 to 72-N, and the controller 100. In FIG. 10, the optical transmitters are denoted as Tx, and the optical receivers are denoted as Rx. J, L, M, and N are integers greater than or equal to two.

In the optical communication system 200, the TDMA signal generation unit 11-1 and the optical transmitters 13-1 to 13-M define the optical transmitting apparatus 10-1, the TDMA signal generation unit 11-2 and the optical transmitters 13-(M+1) to 13-M2 define the optical transmitting apparatus 10-2, ..., and the TDMA signal generation unit 11-N and the optical transmitters 13-(M(N-1)+1) to 13-MN define the optical transmitting apparatus 10-N. The optical receivers 71-1 to 71-M and the TDMA signal selection unit 72-1 define the optical receiving apparatus 70-1, the optical receivers 71-(M+1) to 71-M2 and the TDMA signal selection unit 72-2 define the optical receiving apparatus 70-2, ..., and the optical receivers 71-(M(N-1)+1) to 71-MN and the TDMA signal selection unit 72-N define the optical receiving apparatus 70-N. The optical couplers 20-1 to 20-LM and the optical couplers 60-1 to 60-MN are, for example, power splitters.

In the following description, the optical transmitting apparatuses 10-1 to 10-N are sometimes referred to as the optical transmitting apparatuses 10 when not distinguished, the TDMA signal generation units 11-1 to 11-N are sometimes referred to as the TDMA signal generation units 11 when not distinguished, and the optical transmitters 13-1 to 13-MN are sometimes referred to as the optical transmitters 13 when not distinguished. The optical couplers 20-1 to 20-LM are sometimes referred to as the optical couplers 20 when not distinguished, the optical receivers 30-1 to 30-LM are sometimes referred to as optical receivers 30 when not distinguished, the TDMA switches 40-1 to 40-L are sometimes referred to as TDMA switches 40 when not distinguished, the optical transmitters 50-1 to 50-LJM are sometimes referred to as optical transmitters 50 when not distinguished, and the optical couplers 60-1 to 60-MN are sometimes referred to as optical couplers 60 when not distinguished. The optical receiving apparatuses 70-1 to 70-N are sometimes referred to as the optical receiving apparatuses 70 when not distinguished, the optical receivers 71-1 to 71-MN are sometimes referred to as the optical receivers 71 when not distinguished, and the TDMA signal selection units 72-1 to 72-N are sometimes referred to as the TDMA signal selection units 72 when not distinguished. Further, the optical transmitting apparatuses 10 are sometimes referred to as first optical transmitting apparatuses, the optical couplers 20 are sometimes referred to as first optical couplers, the optical receivers 30 are sometimes referred to as first optical receiving apparatuses, the optical transmitters 50 are sometimes referred to as second optical transmitting apparatuses, the optical couplers 60 are sometimes referred to as second optical couplers, and the optical receiving apparatuses 70 are sometimes referred to as second optical receiving apparatuses.

To perform N×N switching, the optical communication system 200 of the present embodiment includes the TDMA switches 40-1 to 40-L that perform optical-electrical-optical conversion to switch electrical signals. This allows the optical communication system 200 to reduce both the number of signals combined by each optical coupler 20 and the number of separate signals provided by each optical coupler 60 per stage, compared to those in the first to third embodiments, to reduce the loss budget. Furthermore, the optical communication system 200 can extend the signal time width T_{P} per packet, and thus can also reduce the transmission speed required of the optical transmitters 13 and 50 and the optical receivers 30 and 71.

FIG. 11 is a diagram illustrating an example of signals transmitted in the optical communication system 200 according to the fourth embodiment. FIG. 11 also illustrates the sequence of the operations of the optical communication system 200 according to the fourth embodiment. As in the first embodiment etc., each TDMA signal generation unit 11 temporally divides first data that is an input signal to change the first data signal into temporally intermittent electrical-signal packet signals of a signal time width T_{P1}. A TDMA signal generation unit input signal illustrated in FIG. 11 indicates a first data signal that is a signal input to the TDMA signal generation unit 11-1, by way of example. As indicated by output signals from optical transmitter 13 in FIG. 11, the optical transmitters 13 convert the electrical-signal packet signals of the signal time width T_{P1} generated by the TDMA signal generation unit 11, into optical-signal packet signals and transmit the optical-signal packet signals.

As illustrated in FIG. 10, the optical couplers 20-1 to 20-LM each have K input ports and one output port. The optical couplers 20-1 to 20-LM each combine up to K optical-signal packet signals together, and transmit a combined optical-signal transmission signal to the optical receivers 30. FIG. 11 illustrates, as signals to optical receiver 30, an input signal from the optical coupler 20-1 to the optical receiver 30-1, and an input signal from the optical coupler 20-M to the optical receiver 30-M. In the example of FIG. 11, the optical receivers 30-1 and 30-M each receive the optical-signal transmission signal into which the K optical-signal packet signals are combined. The optical receivers 30 convert the received optical-signal transmission signals into data signals that are electrical signals, and transmit the data signals to the TDMA switches 40. K is an integer greater than or equal to two and smaller than N.

The TDMA switches 40-1 to 40-L acquire the electrical-signal data signals from the optical receivers 30 and switch the acquired electrical-signal data signals by destination for transmission to the optical transmitters 50. FIG. 11 illustrates an example in which the TDMA switch 40-1 acquires the data signal from the optical receiver 30-1 and switches the acquired data signal to the optical transmitter 50-1 in order to ultimately transmit, to the TDMA signal selection unit 72-1, the signal generated by the TDMA signal generation unit 11-1. More specifically, the TDMA switch 40-1 outputs, to the optical transmitters 50-1 to 50-M, only a packet signal 1 of the electrical-signal data signal that is electrical-signal packet signals 1 to K acquired from the optical receiver 30-1. For example, to transmit, ultimately to the TDMA signal selection unit 72-2, the above-discussed signal generated by the TDMA signal generation unit 11-1, the TDMA switch 40-1 outputs only the packet signal 1 to the optical transmitters 50-(M+1) to 50-2M. Reference character J for the optical transmitters 50 in FIG. 10 is an integral multiple of M and is a number defined as J=N/M.

The optical transmitters 50 convert the electrical-signal data signals acquired from the TDMA switches 40, into optical-signal packet signals, and output the optical-signal packet signals to the optical couplers 60. Optical transmitter 50 output signals illustrated in FIG. 11 indicate signals output from the optical transmitters 50-1 and 50-M.

As illustrated in FIG. 10, the optical couplers 60-1 to 60-MN each have L input ports and one output port. The optical couplers 60-1 to 60-MN each combine up to L optical-signal packet signals together, and transmit a combined optical signal to the optical receivers 71. FIG. 11 illustrates, as signals input to optical receiver 71, an input signal from the optical coupler 60-1 to the optical receiver 71-1, and an input signal from the optical coupler 60-M to the optical receiver 71-M. In the example of FIG. 11, the optical receivers 71-1 and 71-M each receive an optical-signal transmission signal into which the L optical-signal packet signals are combined. The optical receivers 71 convert the acquired optical-signal transmission signals into electrical-signal transmission signals and output the electrical-signal transmission signals to the TDMA signal selection units 72.

As in the first embodiment, on the basis of routing information included in a second control signal acquired from the controller 100, each TDMA signal selection unit 72 selects the signals in a specified time slot from the electrical-signal transmission signals received from the connected optical receivers 71, and outputs the selected time-slot signals as a second data signal that is an electrical signal. Specifically, each TDMA signal selection unit 72 extracts only a necessary destination on the basis of the routing information, and discards the other signals. Each TDMA signal selection unit 72 converts the temporally intermittent extracted signals into a temporally continuous signal, and changes the transmission speed in conformity with the following system connected thereto before transmitting the continuous signal. A TDMA signal selection unit output signal illustrated in FIG. 11 indicates the second data signal output from the TDMA signal selection unit 72-1, by way of example.

The operation other than the operation of each component described in the present embodiment is the same as the operation of each component described in the first embodiment.

As described above, in the present embodiment, the optical communication system 200 includes: the optical transmitting apparatuses 10-1 to 10-N, which are a plurality of first optical transmitting apparatuses, each of which converts a first data signal that is an electrical signal into a plurality of first optical-signal packet signals and transmits the plurality of first optical-signal packet signals; and the optical couplers 20-1 to 20-LM, which are a plurality of first optical couplers, each of which combines first optical-signal packet signals transmitted from fewer than all of the optical transmitting apparatuses 10-1 to 10-N, the fewer optical transmitting apparatuses being different from each other, and outputs a combined first optical-signal transmission signal. Further, the optical communication system 200 includes: the optical receivers 30-1 to 30-LM, which are a plurality of first optical receiving apparatuses, each of which receives the first optical-signal transmission signal from the corresponding optical coupler 20, converts the first optical-signal transmission signal into a second data signal that is an electrical signal, and outputs the second data signal; and the TDMA switches 40-1 to 40-L, which are a plurality of switches, each of which receives the second data signals from fewer than all of the plurality of optical receivers 30-1 to 30-LM, and switches the second data signals by destination. Further, the optical communication system 200 includes: the optical transmitters 50-1 to 50-LJM, which are a plurality of second optical transmitting apparatuses, each of which receives the second data signal from the corresponding one of the plurality of TDMA switches 40-1 to 40-L, converts the second data signal into a second optical-signal packet signal, and transmits the second optical-signal packet signal; and the optical couplers 60-1 to 60-MN, which are a plurality of second optical couplers, each of which combines second optical-signal packet signals transmitted from fewer than all of the plurality of optical transmitters 50-1 to 50-LJM, the fewer optical transmitters being connected to the different TDMA switches 40, and outputs a combined second optical-signal transmission signal. Further, the optical communication system 200 includes: the optical receiving apparatuses 70-1 to 70-N, which are a plurality of second optical receiving apparatuses, each of which receives the second optical-signal transmission signals from fewer than all of the plurality of optical couplers 60-1 to 60-MN, converts the second optical-signal transmission signals into a third data signal that is an electrical signal, and outputs the third data signal; and the controller 100 that controls the operation of the plurality of optical transmitting apparatuses 10-1 to 10-N and the plurality of optical receiving apparatuses 70-1 to 70-N. The number of signals combined by each optical coupler 20 is smaller than the number of the optical transmitting apparatuses 10, and the number of signals combined by each optical coupler 60 is smaller than the number of the optical transmitters 50. On the basis of the first control signal acquired from the controller 100, each optical transmitting apparatus 10 transmits a plurality of first optical-signal packet signals, allocating communication resources thereto in such a manner as to prevent the transmitted first optical-signal packet signals from colliding with first optical-signal packet signals transmitted from the other optical transmitting apparatuses 10. Each optical receiving apparatus 70 converts second optical-signal transmission signals into electrical-signal transmission signals, and, on the basis of the second control signal acquired from the controller 100, selects specified signal portions from the electrical-signal transmission signals and outputs the selected signal portions as the third data signal.

A hardware configuration of the optical communication system 200 will be described. In the optical communication system 200, the optical receivers 30 and the optical transmitters 50 are photoelectric conversion circuits. The optical couplers 60 are power splitters as described above. The TDMA switches 40 are implemented by processing circuitry. The processing circuitry may be a processor that executes a program stored in memory and the memory, or may be dedicated hardware.

As described above, according to the present embodiment, by controlling transmission timing for the TDMA signal generation unit 11 of each optical transmitting apparatus 10 using TDMA, the optical communication system 200 can configure matrix switch connections only with passive components of the optical couplers 20, without using optical switches in the optical region, and thus can improve reliability. Furthermore, by limiting the number of splits of the optical couplers 20 and the number of signals combined by the optical couplers 60, the optical communication system 200 can reduce the losses of the optical couplers 20 and 60. The present embodiment can further reduce the loss budget depending on how to take the numbers of signals combined and split, compared to the first to third embodiments.

The optical communication system according to the present disclosure has the effect of improving the reliability of the entire system as well as preventing the reduction in line efficiency.

The configurations described in the above embodiments illustrate an example and can be combined with another known art. The embodiments can be combined with each other. The configurations can be partly omitted or changed without departing from the gist.

What is claimed is:

1. An optical communication system, comprising:
a plurality of optical transmitting circuits each to convert a first data signal that is an electrical signal into a plurality of optical-signal packet signals and transmit the plurality of optical-signal packet signals;
a plurality of optical couplers each to combine optical-signal packet signals transmitted from fewer than all of the plurality of optical transmitting circuits, the fewer optical transmitting circuits being different from each other, split the combined optical-signal packet signals into a plurality of optical-signal transmission signals of the same information, and output the plurality of optical-signal transmission signals;
a plurality of optical receiving circuits each to receive optical-signal transmission signals from the plurality of optical couplers, the received optical-signal transmission signals each being one of the separate optical-signal transmission signals provided by a corresponding one of the plurality of optical couplers, convert the optical-signal transmission signals into a second data signal that is an electrical signal, and output the second data signal; and
a controller to control operation of the plurality of optical transmitting circuits and the plurality of optical receiving circuits, wherein
the number of signals combined by each optical coupler is smaller than the number of the plurality of optical transmitting circuits,
on the basis of a first control signal acquired from the controller, each optical transmitting circuit transmits the plurality of optical-signal packet signals, allocating communication resources thereto in such a manner as to prevent the transmitted optical-signal packet signals from colliding with the optical-signal packet signals transmitted from the other optical transmitting circuits, and
each optical receiving circuit converts the optical-signal transmission signals into electrical-signal transmission signals, and, on the basis of a second control signal acquired from the controller, selects specified signal portions from the electrical-signal transmission signals and outputs the selected signal portions as the second data signal.

2. An optical communication system, comprising:
a plurality of optical transmitting circuits each to convert a first data signal that is an electrical signal into a plurality of optical-signal packet signals and transmit the plurality of optical-signal packet signals;
a plurality of optical couplers each to combine optical-signal packet signals transmitted in one-to-one correspondence from the plurality of optical transmitting circuits, split the combined optical-signal packet signals into a plurality of optical-signal transmission signals of the same information, and output the plurality of optical-signal transmission signals;
a plurality of optical receiving circuits each to receive optical-signal transmission signals from fewer than all of the plurality of optical couplers, the received optical-signal transmission signals each being one of the separate optical-signal transmission signals provided by a corresponding one of the fewer optical couplers, convert the optical-signal transmission signals into a second data signal that is an electrical signal, and output the second data signal; and
a controller to control operation of the plurality of optical transmitting circuits and the plurality of optical receiving circuits, wherein
the number of the separate optical-signal transmission signals provided by each optical coupler is smaller than the number of the plurality of optical receiving circuits,
on the basis of a first control signal acquired from the controller, each optical transmitting circuit duplicates the first data signal, and transmits the plurality of optical-signal packet signals, allocating communication resources thereto by destination in such a manner as to prevent the transmitted optical-signal packet signals from colliding with the optical-signal packet signals transmitted from the other optical transmitting circuits, and
each optical receiving circuit converts the optical-signal transmission signals into electrical-signal transmission signals, and, on the basis of a second control signal acquired from the controller, selects specified signal portions from the electrical-signal transmission signals and outputs the selected signal portions as the second data signal.

3. An optical communication system, comprising:
a plurality of optical transmitting circuits each to convert a first data signal that is an electrical signal into a plurality of optical-signal packet signals and transmit the plurality of optical-signal packet signals;
a plurality of optical couplers each to combine optical-signal packet signals transmitted from fewer than all of the plurality of optical transmitting circuits, the fewer optical transmitting circuits being different from each other, split the combined optical-signal packet signals into a plurality of optical-signal transmission signals of the same information, and output the plurality of optical-signal transmission signals;
a plurality of optical receiving circuits each to receive optical-signal transmission signals from fewer than all of the plurality of optical couplers, the received optical-signal transmission signals each being one of the separate optical-signal transmission signals provided by a corresponding one of the fewer optical couplers, convert the optical-signal transmission signals into a second data signal that is an electrical signal, and output the second data signal; and
a controller to control operation of the plurality of optical transmitting circuits and the plurality of optical receiving circuits, wherein
the number of signals combined by each optical coupler is smaller than the number of the plurality of optical transmitting circuits, and the number of the separate optical-signal transmission signals provided by each optical coupler is smaller than the number of the plurality of optical receiving circuits,
on the basis of a first control signal acquired from the controller, each optical transmitting circuit switches between the optical couplers by destination, and transmits the optical-signal packet signals, allocating communication resources thereto by destination in such a manner as to prevent the transmitted optical-signal packet signals from colliding with the optical-signal packet signals transmitted from the other optical transmitting circuits, and
each optical receiving circuit converts the optical-signal transmission signals into electrical-signal transmission signals, and, on the basis of a second control signal acquired from the controller, selects specified signal portions from the electrical-signal transmission signals and outputs the selected signal portions as the second data signal.

4. An optical communication system, comprising:
a plurality of first optical transmitting circuits each to convert a first data signal that is an electrical signal into a plurality of first optical-signal packet signals and transmit the plurality of first optical-signal packet signals;
a plurality of first optical couplers each to combine first optical-signal packet signals transmitted from fewer than all of the plurality of first optical transmitting circuits, the fewer first optical transmitting circuits being different from each other, and output a combined first optical-signal transmission signal;
a plurality of first optical receiving circuits each to receive the first optical-signal transmission signal from a corresponding one of the first optical couplers, convert the first optical-signal transmission signal into a second data signal that is an electrical signal, and output the second data signal;
a plurality of switches each to receive the second data signals from fewer than all of the plurality of first optical receiving circuits and switch the second data signals by destination;
a plurality of second optical transmitting circuits each to receive the second data signal from a corresponding one of the plurality of switches, convert the second data signal into a second optical-signal packet signal, and transmit the second optical-signal packet signal;
a plurality of second optical couplers each to combine second optical-signal packet signals transmitted from fewer than all of the plurality of second optical transmitting circuits, the fewer second optical transmitting circuits being connected to the different switches, and output a combined second optical-signal transmission signal;
a plurality of second optical receiving circuits each to receive the second optical-signal transmission signals from fewer than all of the plurality of second optical couplers, convert the second optical-signal transmission signals into a third data signal that is an electrical signal, and output the third data signal; and
a controller to control operation of the plurality of first optical transmitting circuits and the plurality of second optical receiving circuits, wherein
the number of signals combined by each first optical coupler is smaller than the number of the first optical transmitting circuits, and the number of signals combined by each second optical coupler is smaller than the number of the second optical transmitting circuits,
on the basis of a first control signal acquired from the controller, each first optical transmitting circuit transmits the plurality of first optical-signal packet signals, allocating communication resources thereto in such a manner as to prevent the transmitted first optical-signal packet signals from colliding with the first optical-signal packet signals transmitted from the other first optical transmitting circuits, and
each second optical receiving circuit converts the second optical-signal transmission signals into electrical-signal transmission signals, and, on the basis of a second control signal acquired from the controller, selects specified signal portions from the electrical-signal transmission signals and outputs the selected signal portions as the third data signal.

5. An optical communication method, comprising:
under control of a controller, converting a first data signal that is an electrical signal into a plurality of optical-signal packet signals and transmitting the plurality of optical-signal packet signals;
combining optical-signal packet signals transmitted from fewer than all of a plurality of optical transmitting apparatuses, the fewer plurality of optical transmitting apparatuses being different from each other, splitting the combined optical-signal packet signals into a plurality of optical-signal transmission signals of the same information, and outputting the plurality of optical-signal transmission signals; and
receiving optical-signal transmission signals from a plurality of optical couplers, the received optical-signal transmission signals each being one of the separate optical-signal transmission signals provided by a corresponding one of the plurality of optical couplers, converting the optical-signal transmission signals into a second data signal that is an electrical signal, and outputting the second data signal, wherein
the number of signals combined by each optical coupler is smaller than the number of the plurality of optical transmitting apparatuses,
to convert the first data signal into the plurality of optical-signal packet signals and transmit the plurality of optical-signal packet signals, the method includes, on the basis of a first control signal acquired from the controller, transmitting the plurality of optical-signal packet signals, allocating communication resources thereto in such a manner as to prevent the transmitted optical-signal packet signals from colliding with the optical-signal packet signals transmitted from the other optical transmitting apparatuses, and
to convert the optical-signal transmission signals into the second data signal and output the second data signal, the method includes converting the optical-signal transmission signals into electrical-signal transmission signals, and, on the basis of a second control signal acquired from the controller, selecting specified signal portions from the electrical-signal transmission signals and outputting the selected signal portions as the second data signal.

6. An optical communication method, comprising:
under control of a controller, converting a first data signal that is an electrical signal into a plurality of optical-signal packet signals and transmitting the plurality of optical-signal packet signals;
combining optical-signal packet signals transmitted in one-to-one correspondence from a plurality of optical transmitting apparatuses, splitting the combined optical-signal packet signals into a plurality of optical-signal transmission signals of the same information, and outputting the plurality of optical-signal transmission signals; and
under control of the controller, receiving optical-signal transmission signals from fewer than all of a plurality of optical couplers, the received optical-signal transmission signals each being one of the separate optical-signal transmission signals provided by a corresponding one of the fewer optical couplers, converting the optical-signal transmission signals into a second data signal that is an electrical signal, and outputting the second data signal, wherein
the number of the separate optical-signal transmission signals provided by each optical coupler is smaller than the number of a plurality of optical receiving apparatuses,
to convert the first data into the plurality of optical-signal packet signals and transmit the plurality of optical-signal packet signals, the method includes, on the basis of a first control signal acquired from the controller, duplicating the first data signal, and transmitting the plurality of optical-signal packet signals, allocating communication resources thereto by destination in such a manner as to prevent the transmitted optical-signal packet signals from colliding with the optical-signal packet signals transmitted from the other optical transmitting apparatuses, and
to convert the optical-signal transmission signals into the second data signal and output the second data signal, the method includes converting the optical-signal transmission signals into electrical-signal transmission signals, and, on the basis of a second control signal acquired from the controller, selecting specified signal portions from the electrical-signal transmission signals and outputting the selected signal portions as the second data signal.

7. An optical communication method, comprising:
under control of a controller, converting a first data signal that is an electrical signal into a plurality of optical-signal packet signals and transmitting the plurality of optical-signal packet signals;
combining optical-signal packet signals transmitted from fewer than all of a plurality of optical transmitting apparatuses, the fewer optical transmitting apparatuses being different from each other, splitting the combined optical-signal packet signals into a plurality of optical-signal transmission signals of the same information, and outputting the plurality of optical-signal transmission signals; and
under control of the controller, receiving optical-signal transmission signals from fewer than all of a plurality of optical couplers, the received optical-signal transmission signals each being one of the separate optical-signal transmission signals provided by a corresponding one of the fewer optical couplers, converting the optical-signal transmission signals into a second data signal that is an electrical signal, and outputting the second data signal, wherein
the number of signals combined by each optical coupler is smaller than the number of the plurality of optical transmitting apparatuses, and the number of the separate optical-signal transmission signals provided by each optical coupler is smaller than the number of a plurality of optical receiving apparatuses,
to convert the first data signal into the plurality of optical-signal packet signals and transmit the plurality of optical-signal packet signals, the method includes, on the basis of a first control signal acquired from the controller, switching between the optical couplers by destination, and transmitting the optical-signal packet signals, allocating communication resources by destination in such a manner as to prevent the transmitted optical-signal packet signals from colliding with the optical-signal packet signals transmitted from the other optical transmitting apparatuses, and
to convert the optical-signal transmission signals into the second data signal and output the second data signal, the method includes, converting the optical-signal transmission signals into electrical-signal transmission signals, and, on the basis of a second control signal acquired from the controller, selecting specified signal portions from the electrical-signal transmission signals and outputting the selected signal portions as the second data signal.

8. An optical communication method, comprising:
under control of a controller, converting a first data signal that is an electrical signal into a plurality of first optical-signal packet signals and transmitting the plurality of first optical-signal packet signals;
combining first optical-signal packet signals transmitted from fewer than all of the plurality of first optical transmitting apparatuses, the fewer first optical transmitting apparatuses being different from each other, and outputting a combined first optical-signal transmission signal;
receiving the first optical-signal transmission signal from a corresponding one of the first optical couplers, converting the first optical-signal transmission signal into a second data signal that is an electrical signal, and outputting the second data signal;
receiving the second data signals from fewer than all of the plurality of first optical receiving apparatuses and switching the second data signals by destination;
receiving the second data signal from a corresponding one of the plurality of switches, converting the second data signal into a second optical-signal packet signal, and transmitting the second optical-signal packet signal;
combining second optical-signal packet signals transmitted from fewer than all of the plurality of second optical transmitting apparatuses, the fewer second optical transmitting apparatuses being connected to the different switches, and outputting a combined second optical-signal transmission signal; and
under control of the controller, receiving the second optical-signal transmission signals from fewer than all of the plurality of second optical couplers, converting the second optical-signal transmission signals into a third data signal that is an electrical signal, and outputting the third data signal, wherein
the number of signals combined by each first optical coupler is smaller than the number of the first optical transmitting apparatuses, and the number of signals combined by each second optical coupler is smaller than the number of the second optical transmitting apparatuses,
to convert the first data signal into the plurality of first optical-signal packet signals and transmit the plurality of first optical-signal packet signals, the method includes, on the basis of a first control signal acquired from the controller, transmitting the plurality of first optical-signal packet signals, allocating communication resources thereto in such a manner as to prevent the transmitted first optical-signal packet signals from colliding with the first optical-signal packet signals transmitted from the other first optical transmitting apparatuses, and
to convert the second optical-signal transmission signals into the third data signal, and output the third data signal, the method includes converting the second optical-signal transmission signals into electrical-signal transmission signals, and, on the basis of a second control signal acquired from the controller, selecting specified signal portions from the electrical-signal transmission signals and outputting the selected signal portions as the third data signal.
